(19) United States
(12) Patent Application Publication
(10) Pub. No.: US 2013/0044627 A1
(43) Pub. Date: Feb. 21, 2013

(54) Method of Handling Mobile Device Mobility and Related Communication Device

(71) Applicant: HTC Corporation, Taoyuan County (TW)

(72) Inventor: Yu-Chih Jen, Taoyuan County (TW)

(73) Assignee: HTC CORPORATION, Taoyuan County (TW)

(21) Appl. No.: 13/658,830

(22) Filed: Oct. 24, 2012

Related U.S. Application Data
(62) Division of application No. 12/825,366, filed on Jun. 29, 2010.
(60) Provisional application No. 61/221,096, filed on Jun. 29, 2009.

(51) Int. Cl. H04W 72/04; H04B 7/14; H04W 24/10

(52) U.S. Cl. 370/252; 370/315

(57) ABSTRACT

A method of handling mobility for a mobile device under coverages of a base station and a first relay capable of conveying data between the mobile device and the base station in a wireless communications system is disclosed. The method includes measuring at least a first communication environment of at least a first link with at least a base station to generate at least a first measurement result, measuring at least a second communication environment of at least a second link with at least a relay to generate at least a second measurement result, and reporting at least a channel quality report including at least one of the at least a first measurement result and the at least a second measurement result to a network of the wireless communications system.

### CROSS REFERENCE TO RELATED APPLICATIONS

This application is a divisional of application Ser. No. 12/825,366 filed on Jun. 29, 2010 and entitled “Method of Handling Mobile Device Mobility and Related Communication Device”, which is incorporated by reference herein in its entirety and claims the benefit of U.S. Provisional Application No. 61/221,096, filed on Jun. 29, 2009 and entitled “Method and Apparatus for relaying mobility in a communications system”, the contents of which are incorporated herein in their entirety.

### BACKGROUND OF THE INVENTION

1. Field of the Invention

The present invention relates to a method used in a wireless communications system and related communication device, and more particularly, to a method of handling mobility corresponding to a mobile device in a wireless communications system with relay deployment and related communication device.

2. Description of the Prior Art

A long-term evolution (LTE) system, initiated by the third generation partnership project (3GPP), is now being regarded as a new radio interface and radio network architecture that provides a high data rate, low latency, packet optimization, and improved system capacity and coverage. In the LTE system, a radio access network known as an evolved universal terrestrial radio access network (E-UTRAN) includes a plurality of evolved Node-Bs (eNBs) for communicating with a plurality of user equipments (UEs) and communicates with a core network including a mobility management entity (MME), serving gateway, etc for NAS (Non Access Stratum) control.

Mobility management in the LTE system roughly includes cell selection/reselection, handover and measurement, defined in the document #3GPP TS 36.331 version 8.6 “Radio Resource Control (RRC)” protocol specification. The measurement of the UE includes intra-frequency (e.g. a downlink carrier frequency of a serving cell of the UE), inter-frequency (e.g. frequencies that differ from the downlink carrier frequency) and inter-RAT measurements. The objects for the UE to measure include the serving cell of the UE and cells that are detected for the cell (re)selection.

In addition, a channel quality indicator (CQI) report is reported by the UE once the measurement is configured. The CQI can be a value (or values) representing a measure of channel quality for a channel and may be computed with a signal-to-noise ratio (SNR), signal-to-interference plus noise ratio (SINR) or signal-to-noise plus distortion ratio (SNDR).

A UE in a radio resource control connected mode, RRC_CONNECTED mode, performs the handover controlled by the E-UTRAN. When the measurement report of the UE indicates an unqualified communication quality to the E-UTRAN, the E-UTRAN can request the UE to handover to other cells, frequency layers or radio access technologies (RATs).

The UE performs the cell (re)selection mainly according the measurement criteria and system access control information. The system access control information allows to the UE to know whether a detected cell is completely or partially barred.

A long term evolution-advanced (LTE-A) system, as its name implies, is an evolution of the LTE system, with carrier aggregation and relay deployment. The carrier aggregation allows a UE of the LTE-A system to simultaneously transmit and receive data via multiple carriers, where the UE of the LTE system can only utilize one carrier for data transmission at any time.

A relay node in the LTE-A system is considered to improve the coverage of high data rates, group mobility, temporary network deployment, the cell-edge throughput and to extend coverage. The relay can be deployed at the cell edge where the eNB may be unable to provide required radio quality/throughput for the UEs that shall be served by the eNB or at certain location where radio signals of the eNB may not cover.

Thus, in the LTE-A system, the UE may simultaneously have links with the eNB and the relay capable of communicating with the eNB when the UE is under both coverage of the eNB and the relay. In addition, transparency of the relay can affect data transmission of the links. That is, with deployment of a transparent relay, the UE is not aware of whether or not the UE communicates with the E-UTRAN with the relay. With deployment of a non-transparent relay, the UE is aware of whether or not the UE communicates with the E-UTRAN with the relay. In addition, the relay node can be wirelessly connected to E-UTRAN via a donor cell/base station with inband or outband connection. In the inband case, a donor cell/base station-to-relay link (backhaul link) share the same band with a relay-to-UE link (access link). In the outband case, the donor cell/base station-to-relay link does not operate in the same band as the relay-to-UE link.

With the relay deployment and carrier aggregation that are not considered in the LYE system, the UE in the LTE-A system may face mobility problems when following the LTE specifications. For example, a UE under both coverage of an eNB and a non-transparent relay may measure the communication quality of the non-transparent relay but reports the measurement result to the eNB which considers that the measurement result corresponds to the communication quality between the UE and the eNB. However, the physical communication environment between the UE and the relay mostly quite differs from that between the UE and the eNB. Then, the eNB may manage the mobility of the UE according to the measurement result not reflecting the real communication quality, which could result in provision of worse communication quality to the UE.

Thus, how to perform mobility of the UE in consideration of the relay deployment and carrier aggregation is a topic for discussion.

### SUMMARY OF THE INVENTION

The disclosure therefore provides a method and related communication device for handling mobile device mobility with relay deployment, to avoid an improper mobility management to a mobile device.

A method of handling mobility for a mobile device under coverages of a base station and a first relay capable of conveying data between the mobile device and the base station in a wireless communications system is disclosed. The method includes measuring at least a first communication environment of at least a first link with at least a base station to generate at least a first measurement result, measuring at least a second communication environment of at least a second link with at least a relay to generate at least a second measurement result, and reporting at least a channel quality report including at least one of the at least a first measurement result and the at least a second measurement result to a network of the wireless communications system.

A method of handling mobile device mobility for a network device comprising a base station and a relay in a wireless communications system is disclosed. The method includes utilizing at least one of scheduling of a first reference signal of the relay, scheduling of a second reference signal of the base station, system information at least one of the relay and the base station, and measurement resource allocation corresponding to a mobile device to control the mobile device to measure either communication environment of a first link with the base station or communication environment of a second link with the relay.

A method of handling mobile device mobility for a network device comprising a base station and a relay in a wireless communications system is disclosed. The method includes receiving a channel quality report from a mobile device of the wireless communications system, and performing a first mobility procedure for a link between the mobile device and the base station and a second mobility procedure for a link between the mobile device and the relay, respectively, according to the channel quality report.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an examplary communication device.

FIG. 2 is a schematic diagram of an examplary wireless communications system with relay deployment.

FIG. 3 is a schematic diagram of an examplary wireless communications system with relay deployment.

FIG. 4 is a schematic diagram of an examplary wireless communications system with relay deployment.

FIG. 5 is a schematic diagram of an examplary wireless communications system with relay deployment.

FIG. 6-10 are flowcharts of examplary processes.

### DETAILED DESCRIPTION

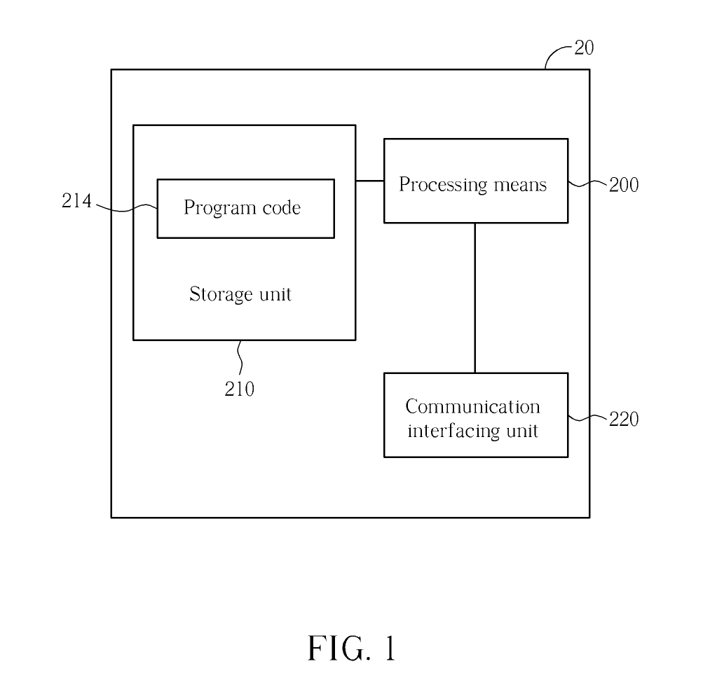

Please refer to FIG. 1, which illustrates a schematic diagram of an examplary communication device 20. The communication device 20 may include a processing means 200 such as a microprocessor or ASIC (Application-Specific Integrated Circuit), a memory unit 210 and a communication interfacing unit 220. The memory unit 210 may be any data storage device that can store program code 214 for access by the processing means 200. Examples of the memory unit 210 include but are not limited to a subscriber identity module (SIM), read-only memory (ROM), random-access memory (RAM), CD-ROMs, magnetic tapes, hard disks, and optical data storage devices. The communication interfacing unit 220 may be preferably a radio transceiver and accordingly exchanges wireless signals with other communication devices according to processing results of the processing means 200.

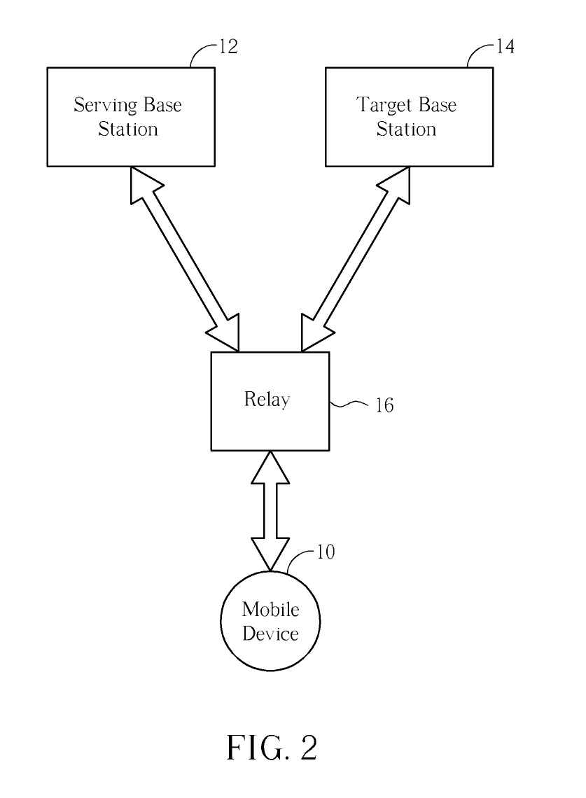

Please refer to FIGS. 2-5, which are schematic diagrams of examplary mobile device location schemes of a wireless communications system supporting relay and simultaneous transmission/reception on multiple carriers (e.g. long term evolution-advanced (LTE-A) system). In all of FIGS. 2-5, a mobile device 10, a serving base station 12, a target base station 14 and a relay 16 are shown, and the mobile device 10 and the relay 16 may be realized by the communication device 20 shown in FIG. 1. In the LTE-A system, the serving base station 12, the target base station 14 and the relay 16 can be regarded as part of a network, i.e. E-UTRAN (evolved-UTRAN), comprising a plurality of eNBs (evolved Node-Bs) each controlling a cell, whereas the mobile device 10 is referred as to a user equipments (UE) that can be devices such as mobile phones, portable computer systems, etc. This terminology will be used throughout the application for ease of reference, and however, this should not be construed as limiting the disclosure to any one particular type of network. The network and the UE can be seen as a transmitter or receiver according to transmission direction, e.g., for uplink (UL), the UE is the transmitter and the network is the receiver, and for downlink (DL), the network is the transmitter and the UE is the receiver.

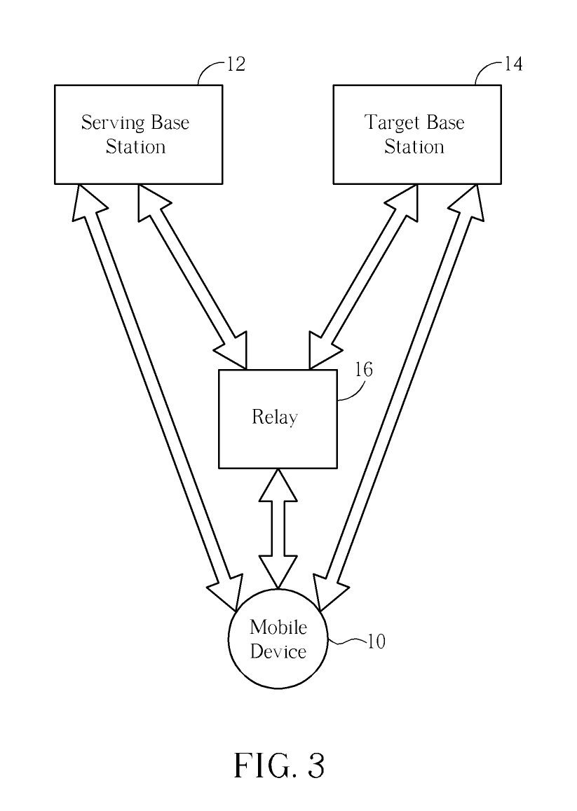

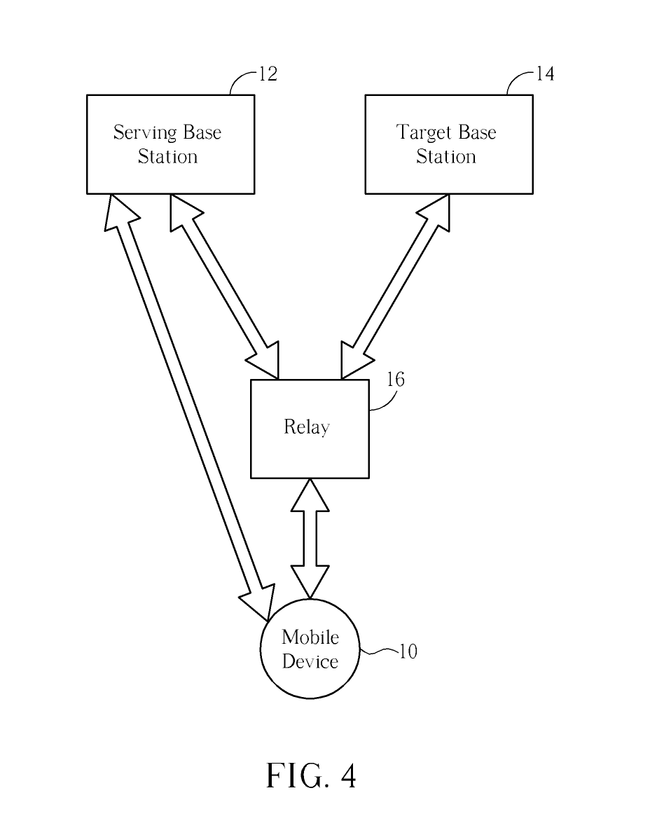

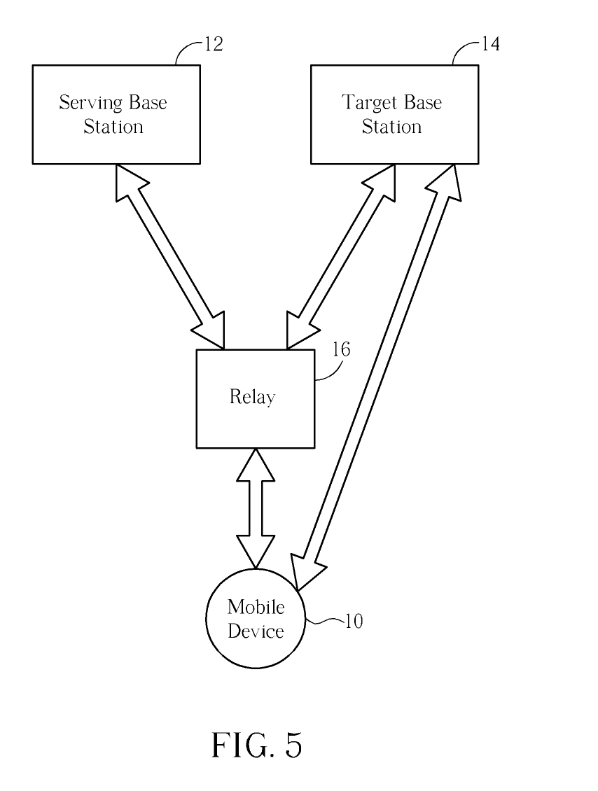

The relay 16 is loacted under both coverage of the serving base station 12 and the target base station 14 and therefore can conveys data between the mobile device 10 and the serving base station 12/the target base station 14. For example, the relay 16 may serve both of the serving base station 12 and the target base station 14 at edges of cells controlled by the serving base station 12 and the target base station 14 between two cells of the two base stations. Or the relay 16 may serve only one of the serving base station 12 and the target base station 14 but can communicate with another base station. The mobile device 10 of FIG. 2 is loacted only under coverage of the relay 16. The mobile device 10 of FIG. 3 is loacted under coverage of the relay 16, the serving base station 12 and the target base station 14. The mobile device 10 of FIG. 4 is loacted under coverage of the relay 16 and the serving base station 12. The mobile device 10 of FIG. 5 is loacted under coverage of the relay 16 and the target base station 14. The mobile device 10 under any of the above-mentioned coverages is able to receive radio signals from the serving base station 12/the target base station 14/the relay 16 at a certain acceptable leve of communication quality and thereby may have links or establish radio resource control (RRC) connections each corresponding to one of the carriers that the mobile device 16 can use. When the relay 16 is a transparent relay, the mobile device 10 is not aware of existence of the relay 16 and considers that all downlink or uplink transmissions are direct transmissions with the serving base station 12/the target base station 14. When the relay 16 is a non-transparent relay, the mobile device 10 is aware of existence of the relay 16. In addition, the relay 16 may include a physical cell identity (PCI) that is assigned to a cell controlled by the relay 16. The PCI is a layer 1 radio signature. When the PCI of the relay 16 is different from all PCIs of cells controlled by the serving base station 12, the target base station 14 and neighboring cells of the relay 16, the PCI of the relay 16 is considered a separated PCI.

In addition, a discontinuous reception (DRX) operation may be used in the mobile device 10 for communicating with the relay 16, the serving base station 12 or the target base station 14 when the mobile device 10 is under corresponding coverage. In the DRX operation, the mobile device 10 can activate monitoring of a physical downlink control channel (PDCCH) during an on duration of a DRX cycle and deactivate the PDCCH monitoring during the rest time of the DRX cycle. The DRX operation may be also used in the relay 16 for communication with the serving base station 12 or the target base station 14.

Mobiltiy management of the mobile device 10 may include cell selection/reselection, handover and measurement. The cell selection/reselection is automatic behavior of the mobile device 10. That is, determining which cell is updated for camping on is the internal behavior of the mobile device 10 itself. The purpose of the disclosure is to handle the mobiltiy with the relay deployment and the simultaneous transmission/reception on multiple carriers.

First, as can be seen from the above, the relay 16 is able to communicate with more than one base station and the mobile device 10 can be under different coverages. Thus, the relay 16 needs to provide different mobility services to the mobile device 10 according to a measurement result received from the mobile device 10, link conditions of a link between the mobile device 10 and the serving base station 12/the target base station 14 (e.g. the mobile device 10 may or may not be able to directly access to the link with the serving base station 12/the target base station 14, or mobile device 10 and the serving base station 12/the target base station 14 may or may be able to hear each other) and mobility causes that the mobile device 10 (e.g. a cause of connection reestablishment triggering the mobile device 10 to reselect a new cell). In addition, the mobility management may also need to be performed according to the transparency of the relay 16 (e.g. transparent or non-transparent) and to whether the relay 16 has a separated physical cell identity (PCI). In addition, the relay 16 may have an identification or identity for indicating whether the relay 16 has a PCI or not.

On the other hand, the mobility management may involve a security procedure where the security information of the mobile device 10 may need to be updated when the mobile device 10 hands over to a different cell controlled by a different base station (e.g. from the cell of the serving base station 12 to the cell of the target base station 14). This can prevent the mobile device from, at downlink, receiving the information for another mobile device which uses the same security information (e.g. keys for generation of integrity or ciphering keys) and the same cell radio network temporary identifier (C-RTNI) assigned by another cell of another base station.

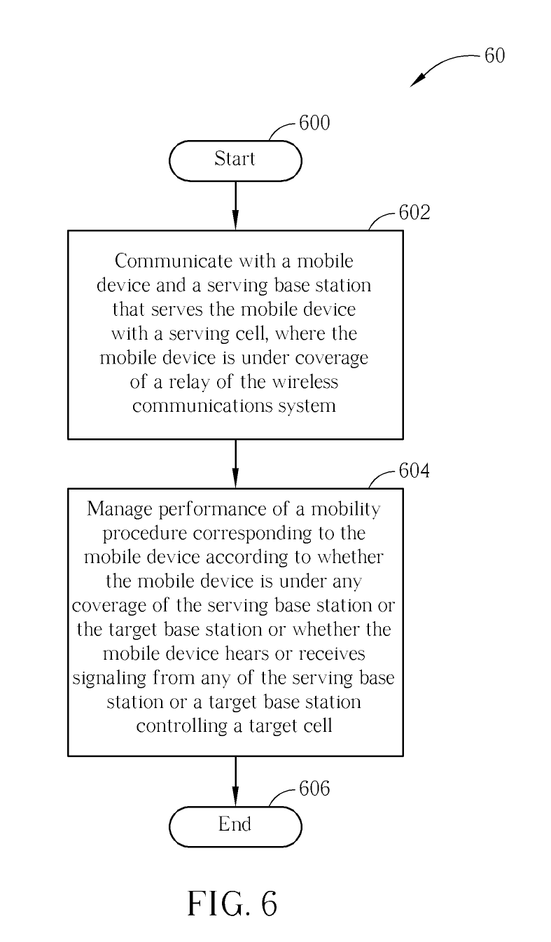

Please refer to FIG. 6, which is a flowchart of an examplary process 60 that is provided under the abovementioned considerations for handling mobile device mobility for a relay in a wireless communications system (e.g. the relay 16 of FIGS. 2-5). The process 60 may be compiled into the program code 214 and includes the following steps:

Step 600: Start.

Step 602: Communicate with a mobile device and a serving base station that serves the mobile device with a serving cell, where the mobile device is under coverage of a relay of the wireless communications system.

Step 604: Manage performance of a mobility procedure corresponding to the mobile device according to whether the mobile device is under any coverage of the serving base station or the target base station or whether the mobile device hears or receives signaling from any of the serving base station or a target base station controlling a target cell.

Step 606: End.

According to the process 60, the relay may communicate with the mobile device and the serving base station of the mobile device by establishing links/RRC connections or by receiving system information from the serving base station/serving cell and broadcasting/sending system information to the mobile device. The relay manages the way to perform the mobility procedure for the mobile device according to (i) whether the mobile device is under any coverage of the serving base station or the target base station or (ii) whether the mobile device hears or receives signaling from any of the serving/target base station, whereby the mobile device is switched to be served by at least one of the relay and the target base station or considers to be under a coverage of the target base station after completion of the mobility procedure. Since the relay can hear the serving/target base station, the mobile device under the relay coverage may be able to hear the serving/target base station. When the mobile device can hear the serving/target base station, the relay may mainly work for throughput enhancement. When the mobile device cannot hear the serving/target base station, the relay may mainly work for coverage extension for the wireless communications system. After the mobility procedure is performed successfully, the relay may or may not terminate the communication with the serving base station. The target base station becomes a new serving base station for replacing the original serving base station. In other words, the target cell becomes a new serving cell of the mobile device. The “serving” or “be served” herein represents that the mobile device camps on a cell controlled by corresponding base station or has connections/links with the base station, via a relay or not. Please note that both the serving and target cells may be controlled by the same base station, i.e. the original serving base station. In other words, the mobile device may actually not change its serving base station while the serving cell is changed. If a relay has its own PCI, this means that the relay controls a cell of its own. In this situation, the target base station selected by the mobile device can be the relay having a PCI.

The mobility procedure may be a handover procedure or a relocation update procedure for updating to the network the location of which cell the mobile device currently camps on. When the relay is transparent, the mobile device may consider receiving the mobility result from either the serving or target base station or consider either the serving or target base station initiates the mobility procedure that may be different from handover procedure. In this situation, the mobile device may initiate a random access procedure to the relay upon detection of initiation of the mobility procedure. The random access procedure may be performed when the relay is a transparent relay. In addition, the purpose of the mobility procedure may be for load balancing of the network. For example, the mobility procedure may need to be performed when the serving base station has heavy load and the target base station has light load. On the other hand, the serving/target base stations may operate in the same frequency band or in the different frequency bands. Accordingly, the relay can operate at the two frequency bands, where some mobile devices under the relay coverage use one frequency band while the rest of mobile devices under the relay coverage use the other frequency band.

The relay may broadcast one set of system information, where the system information is system information associated with the relay/coverage thereof, associated with the serving base station/coverage thereof or the target base station/coverage thereof. Or, the relay may broadcast multiple sets of system information, including system information associated with the serving/target base station/coverage thereof. The system information associated with the serving base station may be set with the same content as the system information associated with the target base station.

One way to perform the mobility procedure is that the relay performs, for the mobile device, the mobility procedure from the coverage of the serving base station/serving cell to the coverage of the target base station/target cell. In other words, the mobile device may not involve the mobility procedure corresponding to the mobile device itself and may just obtain a mobility result of the mobility procedure via a procedure or message from the relay. For example, when the mobile device is not under any coverage of the serving base station or the target base station or when the mobile device can hear or receive signaling from neither the serving base station nor the target base station (as FIG. 2), the relay may perform the mobility procedure by itself without any direct mobility information exchange between the mobile device and the serving/target base station. In this situation, the relay may further indicate a mobility result of the mobility procedure to the mobile device by sending a message. The message may be a reconfiguration message, system information change message, a specific mobility message, or a security configuration message to send the mobility result. The mobility result may include at least an indication used for notifying the mobile device that the target base station/target cell is a new serving base station/target cell (e.g. a new PCI of the target base station/target cell), and/or security information associated with the target base station/target cell, and/or radio resource characteristics of the target base station/target cell, and/or system information of the target base station/target cell. The security information may be security key(s) as one in a handover command to be derived. Or the security information may be derived security key(s) so that mobile device does not need to derive the key(s) for integrity protection and ciphering. In addition, the relay may perform a random access procedure with the mobile device after completion of the mobility procedure when the relay is a transparent relay.

Furthermore, the mobile device under the coverage of FIG. 2 may consider the mobility procedure as an intra-relay reconfiguration, when the relay has a separated PCI. The mobile device knows that the relay is an agent of performing the mobility procedure for the mobile device, when the relay has a non-separated PCI.

When the relay performs the mobility procedure for the mobile device, the relay may broadcast one or more sets of system information as follows. The one set of system information may be system information associated with the relay or coverage thereof, system information associated with the serving base station or coverage thereof, or system information associated with the target base station or coverage thereof. The sets of system information may include system information associated with the serving base station or coverage thereof and system information associated with the target base station or coverage thereof.

Ways for the relay to perform the mobility procedure for the mobile device are provided as below. In the first way, the relay may receive from the serving base station a mobility command that requests the mobile device to leave. Then the relay may initiate, with the target base station, a request-response mobility procedure in which the relay sends to the target base station a request message for asking if the target base station can serve the mobile device or not, and then the target base station sends to the relay a response message that may accept or reject the request. In the second way, the relay may first initiate a sub-mobility procedure for stopping the mobile device from being served by the serving base station. Then, the relay initiates another sub-mobility procedure with the target base station for switching the mobile device to be served by the target base station. The third way is to exchange the performing order of the sub-mobility procedures with the serving/target base stations.

The relay may further initiate a definable procedure to complete the mobility management/mobility procedure of the mobile device (e.g. the relay may expect a response message from the mobile device). The definable procedure may be a reconfiguration procedure, a system information change procedure, or a security configuration procedure.

Another way to perform the mobility procedure is as below. The relay assists the mobile device in performing the mobility procedure between the serving/target base stations when the mobile device is under coverage as depicted in any of FIGS. 2-5. In one assisting way, when the mobile device is under the coverage of the serving base station and the coverage of the target base station (FIG. 3) or when the mobile device hears signaling from the serving base station and the target base station (FIG. 3), the serving base station and/or the relay may convey commands of the mobility procedure for the mobile device, whereas the serving base station and/or the relay and/or the target base station may convey messages of the mobility procedure for the mobile device.

When the mobile device is under the coverage of the serving base station but not under the coverage of the target base station (FIG. 4), or when the mobile device hears signaling from the serving base station but does not hear any signaling from the target base station (FIG. 4), the serving base station and/or the relay may convey commands of the mobility procedure, whereas the serving base station and/or the relay may convey messages of the mobility procedure between the mobile device and the serving base station. The relay may further perform a sub-mobility procedure of the mobility procedure with the target base station without any data being conveyed in the sub-mobility procedure between the mobile device and the target base station. In this situation, the mobile device can be switched to be served by at least one of the relay and the target base station or can consider to be under the coverage of the target base station after the completion of the first sub-mobility procedure.

When the mobile device is under the coverage of the target base station but not under the coverage of the serving base station (FIG. 5), or when the mobile device hears signaling from the target base station but does not hear any signaling from the serving base station (FIG. 5), the relay may convey commands of the mobility procedure, whereas the relay and/or the target base station may convey messages of the mobility procedure between the mobile device and the target base station. The relay may further perform a second sub-mobility procedure of the mobility procedure with the serving base station without any data conveying of the second sub-mobility procedure between the mobile device and the serving base station. The mobility procedure of any of FIGS. 3-5 is a handover procedure or a relocation update procedure, and the purpose of the mobility procedure is network load balancing or channel condition change.

In another assisting way, the relay may convey the messages/commands of the mobility procedure between the mobile device and the target base station and perform a second sub-mobility procedure with the serving base station without any data conveying of the second sub-mobility procedure between the mobile device and the serving base station, when the mobile device is under the coverage of the target base station (e.g. FIGS. 3 and 5). The relay may further indicate a mobility result of the first or second sub-mobility procedure to the mobile device. The content of the mobility result can refer the foregoing description.

In the abovementioned assisting ways, the relay may know/obtain/maintain system information of the serving base station/serving cell and/or the target base station/target cell. The relay may broadcast one or more sets of system information as follows. The set of system information may be system information of the relay/coverage thereof, system information of the serving base station/coverage thereof, system information of the target base station/coverage thereof, system information associated with the serving base station/coverage thereof, or system information associated with the target base station/coverage thereof. Or, the set of system information may be independent to system information of the serving base station/coverage thereof, or system information of the target base station/coverage thereof. The sets of system information may include system information of the serving base station/coverage thereof and system information of the target base station or coverage thereof, or include system information associated with the serving base station/coverage thereof and system information associated with the target base station/coverage thereof. Or the sets of system information may be independent to system information of the serving base station/coverage thereof and system information of the target base station/coverage thereof. The system information of a relay/base station may mean that the relay/base station generates its own system information. The system information associated with a relay/base station/coverage thereof may mean that the content of the system information indicates system information of the relay/base station/coverage thereof.

In this situation, the relay can snoop/read a handover command from the serving base station, a random access response (RAR) and a contention resolution message from the target base station, and can forward a message of a PRACH (Physical Random Access Channel) and a message 3 of the random access procedure. In addition, the serving/target base stations/cells (e.g. FIG. 3), or the relay and either serving or target base station (e.g. FIG. 4 or 5), can use the same system information if the relay/serving base station/target base station are operated in band and coordinative. In this situation, the target base station may have to assign a dedicated preamble for random access to the mobile device. When the mobile device is not under the coverage of the serving base station, the dedicated preamble can be used by another mobile device under coverage of the serving base station. Alternatively, the dedicated preamble may not be used by any other mobile device under the coverage of the serving base station, or the serving base station does not response to the dedicated preamble assigned to the mobile device. To achieve this, the serving and target base stations may need to coordinate for the utilization of dedicated preambles.

The conveyed messages/commands of the mobility procedure as above mentioned may include a dedicated preamble that the target base station assigns to the mobile device for random access and/or a mobility command from the serving base station to the mobile device. The dedicated preamble may be also used by another mobile device of the serving base station when the mobile device is not under the coverage of the serving base station. The mobility command is mainly used for requesting the mobile device to leave the serving base station.

In any of the coverages as FIG. 3-5, the relay may forward/convey data of uplink/downlink transmissions during the mobility procedure. In this situation, the target base station may assign a dedicated preamble for random access to the mobile device, where the dedicated preamble cannot be used by another mobile device under the coverage of the serving base station. To achieve this, the serving and target base stations may need to coordinate value ranges of the dedicated preamble first, so as to prevent the same dedicated preamble content from being used by both the serving and target base stations. And the serving base station does not response to the dedicated preamble sent by the mobile device.

Furthermore, with the coverage as FIG. 5, the target base station may assign a dedicated preamble for random access of the mobile device, where the dedicated preamble can be used by another mobile device under coverage of the serving base station. The relay may initiate the second sub-mobility procedure with the target base station for the mobile device after receiving the mobility command from the serving base station. This is because the relay may know that the mobile device cannot hear the serving base station directly, according to a previously-obtained measurement report. The relay may perform the second sub-mobility procedure by itself without any mobility information exchange between the mobile device and the serving/target base station. In this situation, the relay may indicate a mobility result of the second sub-mobility procedure to the mobile device. The relay may utilize a reconfiguration message, system information change message, a specific mobility message, or a security configuration message to send the mobility result. The content of the mobility result may refer to foregoing description. The relay in coverage as FIG. 3-5 may be a transparent or non-transparent relay and have a separated or non-separated PCI.

In any of the coverages as FIG. 2-5, the relay may receive a mobility command of the mobile device from the serving base station. In this situation, the relay may initiate a sub-mobility procedure to the target base station for the mobile device after the mobility command is received. Then, the relay may receive a mobility response message of the sub-mobility procedure from the target base station/target cell. Then, the relay may send a message to the mobile device to indicate a mobility result of the mobility procedure or initiating a definable procedure to complete the mobility procedure, wherein the relay expects a response message from the mobile device during the definable procedure. The message may be a reconfiguration message, a system information change message, a mobility message, or a security configuration message. The mobility result may include the same content as the above mentioned. After this, the relay may further initiate another sub-mobility procedure to the serving base station/serving cell and thereby receive corresponding mobility response message from the serving base station/serving cell.

In any of the coverages as FIG. 2-5, the relay also may initiate a sub-mobility procedure to the serving base station/serving cell. Then, the relay may receive corresponding response message from the serving base station/serving cell. After this, the relay may initiate another sub-mobility procedure to the target base station/target cell and receive corresponding mobility response message from the target base station/target cell. The mobility response message may be a reconfiguration message, a system information change message, a mobility message, or a security configuration message.

In any of the coverages as FIG. 2-5, the relay also may receive a mobility request of the mobile device, wherein the mobility request indicates that the mobile device attempts to move to the target base station/target cell. The relay may finish the mobility procedure for the mobile device by initiating a sub-mobility procedure to the target base station/target cell or by sending a mobility request message to the target base station/target cell. The relay may receive a mobility response message corresponding to the sub-mobility procedure or to the mobility request message from the target base station/target cell. After this, the relay may send a message to the mobile device to indicate the mobility result of the mobility procedure or initiate a procedure to complete the mobility procedure, wherein the relay expects a response message from the mobile device during the procedure. In this situation, the relay may be a transparent relay or a non-transparent relay; and the coverage of the relay has a separated identity or has no separated identity.

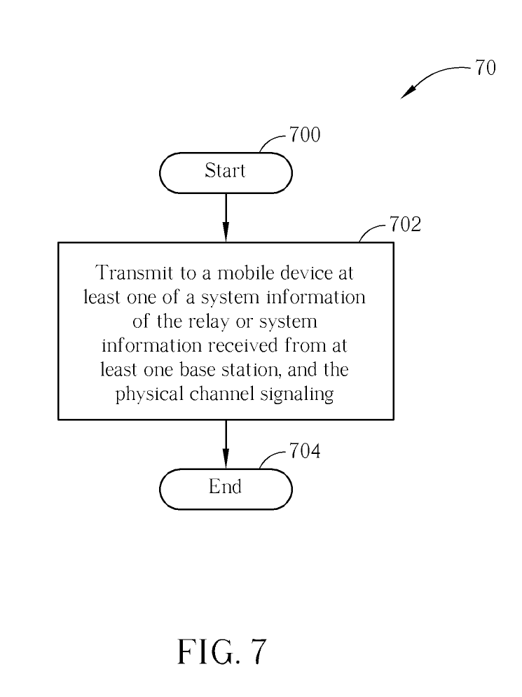

Please refer to FIG. 7, which is a flowchart of an examplary process 70 that is provided for handling mobile device mobility for a relay in a wireless communications system (e.g. the relay 16 of FIGS. 2-5). The process 70 may be compiled into the program code 214 and includes the following steps:

Step 700: Start.

Step 702: Transmit to a mobile device at least one of a system information of the relay or system information received from at least one base station, and the physical channel signaling.

Step 704: End.

According to the process 70, the relay (considered the relay and coverage thereof in the process 70 for simplicity) may transmits the system information(s) of the relay its own and/or the system information from the serving or other base station(s) so that the mobile device under the relay coverage can receive the system information and further receive control signaling and/or physical channel signaling (or how to receive the control signaling and/or physical channel signaling) according to the system information. The system informations may include a relay identity or a relay indication. The relay may be a transparent or non-transparent relay, and/or the relay has scheduling control ability, and/or the relay has a separated physical cell identity. The physical channel signaling may be signaling on a synchronization channel (SCH) of the relay or a SCH of the base station. Thus, the mobile device can perform related mobility procedure (e.g. whether or not to change the serving base station or move to a base station) according to the abovementioned received system information/signaling.

The relay may transmit the system informations by a time division multiple access or multiplexing (TDM) method. For example, the relay transmits the system information of its own at different time from the time the relay transmits the system information from the base station. In other words, transmissions of the system informations of the relay its own and the base station(s) are staggered in time domain. Or, the relay may transmit the system informations by an out-band method. For example, the frequency band/carrier/channel for transmitting the system information of the relay is different form the frequency band/carrier/channel for transmitting the system information from base station. The frequency band may be a band of a physical broadcast channel (PBCH) and/or a physical downlink shared channel (PDSCH). Or, the relay may transmit the system informations by a partial system information method (channel division method) that divides the system informations in different channels some of which are used by the relay. For example, the relay does not transmit all the system informations on the PBCH but some on the PDSCH, or the relay transmits the same PBCH with prescheduled or dynamic PDSCH signaling.

With the process 70, the mobile device may accordingly maintain/use two sets of system information corresponding to the relay and the base station respectively. Or, the mobile device may maintain/use one set of system information which is either broadcast by the relay or by the serving base station.

In the cell (re)selection of the mobility management, the mobile device shall determine whether to move to a base station or coverage thereof, or whether to change coverage of a base station or to change a base station which the mobile device has been served by or camped on. In addition, the mobile device may determine how to receive physical channel signaling according to the abovementioned system information. These can reduce frequent mobility and enhance service continuity of the mobile device.

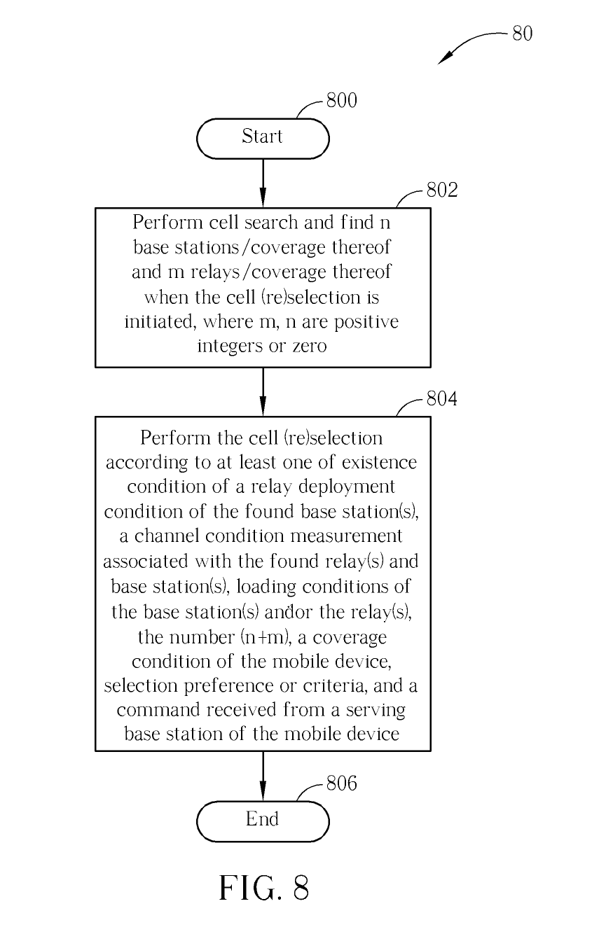

Please refer to FIG. 8, which is a flowchart of an examplary process 80 that is provided under the cell (re)selection considerations for handling mobility for a mobile device in a wireless communications system. The process 80 may be compiled into the program code 214 and includes the following steps:

Step 800: Start.

Step 802: Perform cell search and find n base stations/coverage thereof and m relays/coverage thereof when the cell (re)selection is initiated, where m, n are positive integers or zero.

Step 804: Perform the cell (re)selection according to at least one of existence condition of a relay deployment condition of the found base station(s), a channel condition measurement associated with the found relay(s) and base station(s), loading conditions of the base station(s) and/or the relay(s), the number (n+m), a coverage condition of the mobile device, selection preference or criteria, and a command received from a serving base station of the mobile device.

Step 806: End.

According to the process 80, the mobile device finds n base stations and m relays during the cell search of the cell (re)selection and then determines which base station/cell to camp on, according to the relay deployment condition of the found base station(s) and/or the channel condition of the found relay(s) and/or the channel condition of the found relay(s) and/or the loading conditions of the base station(s) and the relay(s) and/or the number (n+m) and/or a coverage condition of the mobile device (e.g. the mobile device may only camp on the relay since that relay is the only choose) and/or the command received from the serving base station.

The mobile device may obtain the existence condition of the relay deployment condition, by detecting whether a relay exists in coverage of the found base station(s) according to a root sequence/root sequence group (e.g. a synchronization channel of the cell of the base station uses a root sequence, or cell information which indicates that the relay is deployed) and/or a pattern, period or type of a reference signal (e.g. a specific relay indication reference signal, whether a channel state information reference signal, CSI-RS, is used other than common reference signals (CRSs), different reference signal pattern or period) and/or system information and/or a relay indication and/or a frequency band allocated for the relay. The CRS are also known as cell-specific reference signals, well known in the art.

The command received from the serving base station may be a broadcasted message or dedicated message to the mobile device. When the mobile device receives the command, the mobile device may only (re)select a cell/base station deployed with a relay or only (re)select a relay, not a base station, to camp on.

The mobile device may camp on a found relay when any of the following conditions is met:

(i) when the mobile device only detects/finds one relay that has a PCI that is identical to a PCI of another relay (i.e. non-separated PCI)/cell identity or the mobile device identities that the mobile device can only receive signaling for the cell selection or reselection from the found relay, where the cell identity herein is used for indicating whether the relay has a PCI or not;

(ii) when the mobile device detects/finds one relay that has a non-separated PCI or no cell identity or the mobile device identities that the mobile device can only receive signaling for the cell selection or reselection from the found relay; and

(iii) when the mobile device detects/finds one relay that has a separated PCI/cell identity or the mobile device identities that the mobile device can only receive signaling for the cell selection or reselection from the found relay.

In addition, the camped relay may have a relay identity that is unique from other relay identities of the neighboring/surrounding relays so that the mobile device does not detect/find two or more relays with the same relay identity in the surrounding area). The cell (re)selection may be performed for connection (re)establishment procedure (e.g. RRC connection setup or reestablishment due to radio link failure or handover failure), location registration, RRC reconfiguration or a mobility procedure. The mobile device may further perform a random access procedure with the relay directly or with the base station/cell through the relay. Accordingly, the relay may perform the connection (re)establishment for the mobile device or the relay node assists the mobile device in the (re)establishment or the mobility procedure, as described as mentioned above. In addition, the relay may transmit system information (e.g. system information of its own or forwarding system information of the base station so that mobile device under the relay coverage can receive system information broadcasted/sent under the relay coverage) and/or control signaling and/or physical channel signaling (e.g. the SCH of the relay its own or forwarding SCH signaling of the base station). The relay is a transparent or non-transparent relay.

In addition, the mobile device may perform the cell (re)selection based on the relay deployment condition when two cells/base stations have similar channel condition that may be obtained through a measurement procedure for the cell (re)selection. For example, when only one of the cells is deployed with a relay, the mobile device may select the cell with the relay. Taking another example, when the cells are both deployed with a relay, the mobile device may select the cell whose relay has better channel condition.

In the measurement of the mobility management, a channel quality indicator (CQI) report for reporting channel quality of a target node (e.g. a channel communicating with a relay or with a base station) needs to be reported when the measurement is configured. However, with relay deployment, radio link conditions are different between coverage of a base station and a relay. Therefore, to achieve power control, interference control and the mobility management, the network should be able to acquire the CQI report from the mobile device for both coverage of a base station and a relay node. Or, the network may control the mobile device to measure either the relay link condition or the base station link condition by scheduling of reference signal (e.g. the mobile device may or may not know whether it measures the relay link condition or the base station link). Or, the network may know whether the relay link or base station link is measured according to the CQI report (e.g. via different reference signal pattern, type, period and when the report is being reported). The network may know when the report is being reported according to different on-duration timings of the base station or the relay under the DRX operation. In addition, when the CQI report that could be sent, the CQI report should be sent based on DRX configurations of the base station and the relay and/or TDM transmission operation of the relay. In the TDM transmission operation, the UL transmission of the mobile device is allowed for a transparent or non-transparent relay.

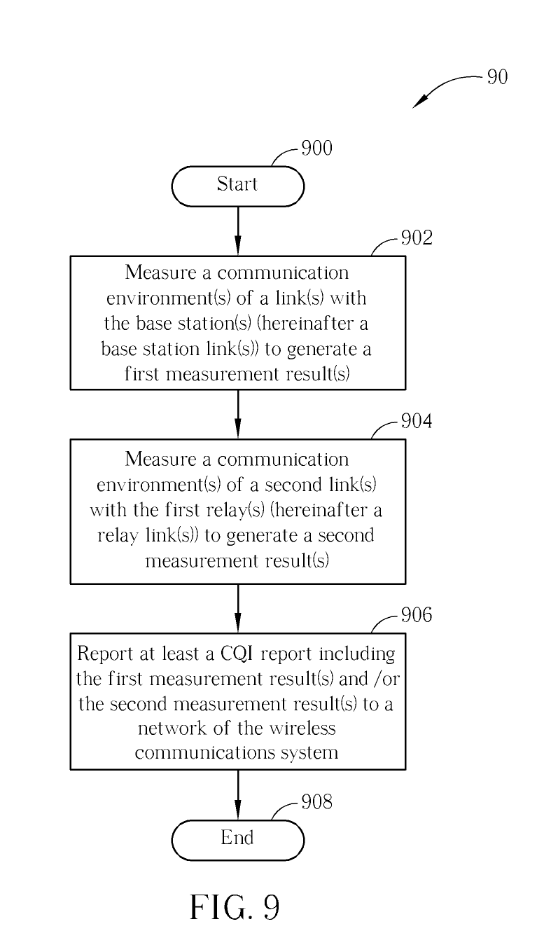

Please refer to FIG. 9, which is a flowchart of an examplary process 90 that is provided under the measurement considerations for handling mobility for a mobile device in a wireless communications system. The process 90 may be compiled into the program code 214 and includes the following steps:

Step 900: Start.

Step 902: Measure a communication environment(s) of a link(s) with the base station(s) (hereinafter a base station link(s)) to generate a first measurement result(s).

Step 904: Measure a communication environment(s) of a second link(s) with the first relay(s) (hereinafter a relay link(s)) to generate a second measurement result(s).

Step 906: Report at least a CQI report including the first measurement result(s) and/or the second measurement result(s) to a network of the wireless communications system.

Step 908: End.

According to the process 90, the mobile device measures the communication environments of the base station/relay links to generate the first and second measurement results respectively and reports the measurement results to the network via one or more CQI reports. For example, under the relay deployment, the mobile device reports one channel quality/state report including both the measurement results of the base station(s) and the relay node(s), or reports separated multiple channel quality/state reports for the measurement results respectively. In addition, the mobile device may determine whether to measure the communication environment of the relay link and/or of the base station link, according to a message received from the network. According to the CQI report from the mobile device, the network may perform (e.g. signal to the UE after processing) distinct power control (a power control procedure or related parameters) for links with the base station and the relay respectively or perform interference coordination (e.g. inter-Cell Interference Coordination, ICIC), or mobility procedure. Through the abovementioned actions which the network performs based on the CQI report, the mobile device may be able to know whether the link with the base station or the relay is measured.

The CQI report(s) may be sent to the network according to a DRX operation, transmission timing of the relay or uplink grant allocation assigned by the network. For example, the CQI report(s) can be sent when the mobile device is awake and the DRX operation is configured/activated for the mobile device. The transmission timing of the relay may means that the relay staggers the transmission time slots with the base station and the mobile device. The transmission timing of the relay may be operated by time division multiple access or multiplexing (TDMA or TDM). In this situation, the mobile device does not send the CQI report on the time slots where the relay uses to communicate with the network to avoid transmission collision. For example, the mobile device can only send the CQI report at a subframe(s) allocated for uplink transmission (e.g. where the relay does not perform transmission with either the mobile device or the base station in band). The subframe(s) may be a subframe 3 and/or a subframe 8 of a radio frame (e.g. subframe number, SFN). In this situation, the mobile device may expect to receive a feedback message corresponding to the subframe 3 and/or 8. In addition, the mobile device may retransmit the CQI report with or without update of the CQI report (i.e. re-measurement for the links and then re-generation for the CQI report) to the network. On the other hand, the mobile device may receive an uplink grant from the PDCCH control signaling and sends the CQI report on a subframe indicated by the PDCCH control signaling based on the uplink grant.

The mobile device may be able to identify the relay. For example, the coverage of the relay, which may be a non-transparent relay, may be identified by the mobile device according to at least one of the root sequence/root sequence group, a pattern, period or type of a reference signal, system information of the base station/relay, a relay indication, and a frequency band allocated of the relay(s). The details can refer to the abovementioned description. In addition, the mobile device may utilize a phase lock loop (PLL) unit to perform tracking/coherent detection of the reference signal.

The mobile device may include at least one of a relay indication and a PCI of coverage of the base station(s) attached by the relay(s) for the second measurement result in the measurement report when the coverage of the relay(s) has no PCI. Furthermore, the mobile device may include at least one of a relay indication and a PCI of the relay in the second measurement result when the PCI is unique from the PCIs of other relays (i.e. separated PCI).

Regardless of whether the relay has a separated PCI or not, the second measurement result may include a relay indication (e.g. a bit or a relay identity) and/or a PCI of the donor base station that dominates serving control for the mobile device that is served by multiple base stations.

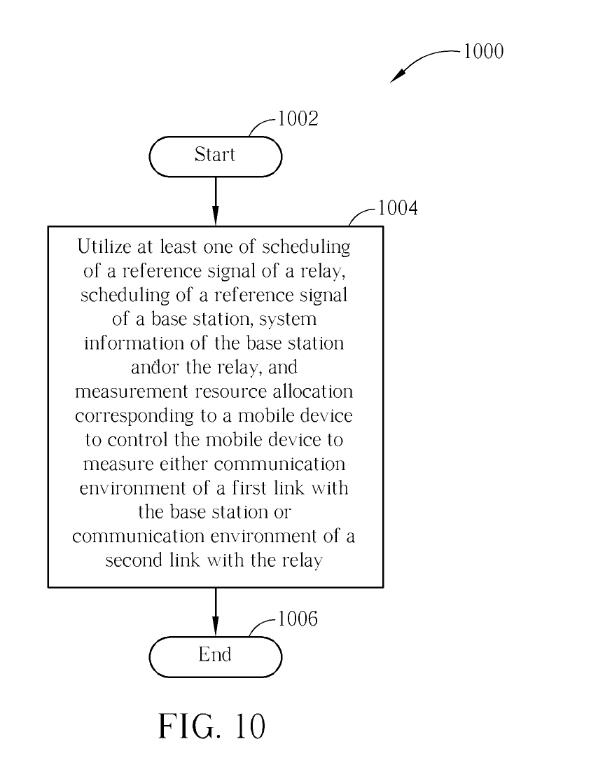

Please refer to FIG. 10, which is a flowchart of an examplary process 1000 that is provided under the measurement considerations for handling mobility for a network in a wireless communications system. The process 1000 may be compiled into the program code 214 and includes the following steps:

Step 1002: Start.

Step 1004: Utilize at least one of scheduling of a reference signal of a relay, scheduling of a reference signal of a base station, system information of the base station and/or the relay, and measurement resource allocation corresponding to a mobile device to control the mobile device to measure either communication environment of a first link with the base station or communication environment of a second link with the relay.

Step 1006: End.

According to the process 1000, the network controls the mobile device to measure either the condition of the relay link or the base station link by the scheduling of the reference signals from relay(s) and base station(s), or by system information indication, or by allocation of measurement resource. For example, the types, patterns, periods, or frequency bands of the reference signals for the base station and the relay are configured to be different so that the mobile device can know which link to measure according to which type, pattern, period, or frequency band of the reference signal is assigned or received. The allocation of measurement resource can indicate to the mobile device what time and what frequency band can be utilized for link measurement or for measurement reporting. The network may allow the base station to add system information indication in the broadcast system information so that the mobile device can know which link(s) to measure by receiving the system information.

The measurement may be performed also for power control and/or interference control in addition for mobility management. The mobile device may report a channel quality/state report (e.g. CQI report) after being controlled to perform the measurement. In this situation, the network may identify which of the relay link or the base station link (or both) is measured by the mobile device, according to the channel quality/state report (e.g. measurement on different reference signal patterns, types, periods, frequency bands), and/or measurement resource that the mobile device uses for the channel quality/state reporting, and/or a specific indication (e.g. an indication dedicated to the relay or to the base station), and/or identity (e.g. the PCI of the base station or the relay identity). Also, the network may identify which of the relay link or the base station link (or both) is measured by the mobile device, according to when the channel quality report/state is transmitted or received (e.g. on-durations of the base station or the relay at different DRX configurations where the on durations are used to report the channel quality report/state).

Please note that, the abovementioned steps of the processes including suggested steps can be realized by means that could be hardware, firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include system on chip (SOC), system in package (Sip), computer on module (COM), and the communication device 20.

In conclusion, the examples provides ways to deal with mobile management (including aspects of handover, cell (re)selection, and measurement) for the mobile device in the wireless system with relay deployment to prevent the network from providing the mobile device with worse communication environment.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of handling mobility for a mobile device in a wireless communications system, the method comprising:
measuring at least a first communication environment of at least a first link with at least a base station to generate at least a first measurement result;
measuring at least a second communication environment of at least a second link with at least a relay to generate at least a second measurement result; and
reporting at least a channel quality report including at least one of the at least a first measurement result and the at least a second measurement result to a network of the wireless communications system.

2. The method of claim 1 further comprising identifying the coverage of the at least a relay, according to at least one of a root sequence or a root sequence group, a pattern, period or type of a reference signal, system information of the at least a relay or the at least a base station, a relay indication, and a frequency band of the at least a relay.

3. The method of claim 2 further comprising using a phase lock loop unit to perform a tracking or coherent detection of the reference signal.

4. The method of claim 1 further comprising:
including at least one of a relay indication of a first relay and a physical cell identity of coverage of the at least a base station attached by the first relay for the second measurement result in the measurement report when coverage of the first relay has no physical cell identity; or
including at least one of a relay indication and a first physical cell identity of the first relay in the second measurement result.

5. The method of claim 1, wherein the at least a relay is a non-transparent relay.

6. The method of claim 1 further comprising determining whether the mobile device measures the first communication environment or the second communication environment, according to a message received from the network.

7. The method of claim 1, wherein reporting at least a channel quality report to the network comprises:
sending the at least a channel quality report to the network according to a discontinuous reception operation, transmission resource of the relay or uplink grant allocation assigned by the network.

8. A method of handling mobile device mobility for a network device comprising a base station and a relay in a wireless communications system, the method comprising:
utilizing at least one of scheduling of a first reference signal of the relay, scheduling of a second reference signal of the base station, system information at least one of the relay and the base station, and measurement resource allocation corresponding to a mobile device to control the mobile device to measure either communication environment of a first link with the base station or communication environment of a second link with the relay.

9. The method of claim 8 further comprising:
receiving a channel quality report from the mobile device; and
identifying whether the channel quality report corresponds to the first link or the second link, according to at least one of measurement characteristics of the channel quality report, resource that the mobile device uses for reporting the channel quality report, an indication dedicated to the relay or to the base station, and an identity of the base station or the relay; or
further comprising:
identifying whether a channel quality report corresponds to the first link or the second link, according to configurations of a discontinuous reception operation of the relay and the base station.

10. A method of handling mobile device mobility for a network device comprising a base station and a relay in a wireless communications system, the method comprising:
receiving a channel quality report from a mobile device of the wireless communications system; and
performing a first mobility procedure for a link between the mobile device and the base station and a second mobility procedure for a link between the mobile device and the relay, respectively, according to the channel quality report.
